(19) United States
(12) Patent Application Publication
(10) Pub. No.: US 2008/0022855 A1
(43) Pub. Date: Jan. 31, 2008

(54) Filter cleaning system and method

(75) Inventor: Jack Thomas Clements, Lee's Summit, MO (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: BHA Group, Inc.

(21) Appl. No.: 11/493,237

(22) Filed: Jul. 26, 2006

(51) Int. Cl. B01D 46/04

(52) U.S. Cl. 95/280; 55/302

(57) ABSTRACT

A filter cleaning system for use with a fabric filter mounted in a housing and defining an upstream side at which particulates are separated from a fluid stream passing through the filter and collected. The fabric filter also has a downstream side that is substantially free of the particulates. The filter cleaning system comprises a blowpipe for supplying a pressurized fluid. A one-piece nozzle is made from a tubular member having a substantially constant cross-section extending along the length of the member. The nozzle is attached to the blowpipe at a first end portion. The nozzle is in fluid communication with the blowpipe to direct a portion of the pressurized fluid from a second opposite end portion into the downstream side of the filter to dislodge particulates from the upstream side. An aspirator is located upstream and spaced from the second end portion of the nozzle. The aspirator enables an extra volume of fluid to be delivered from the second end portion of the nozzle than is delivered from the blowpipe to the first end portion of the nozzle.

### BACKGROUND OF THE INVENTION

1. Field of the Invention

The invention generally relates to a system and method for cleaning fabric filter elements. In particular, the invention relates to a system and method for reverse pulse-jet cleaning of fabric filters in an inlet housing of a gas turbine.

2. Description of the Prior Art

It is known that fabric filters are used to separate particulates from flowing fluids. The particulates tend to accumulate on and in the fabric filter media over time. This particulate accumulation increases resistance to flow through the fabric filter. Increased resistance to flow is undesirable because it inhibits fluid flow through the fabric filter and/or requires more power to effect flow through the fabric filter.

In some known systems, reverse pulse-jet cleaning is used to periodically remove accumulated particulates from the filter media. Using reverse pulse-jet cleaning increases the service life of the filter by removing accumulated particulates to decrease the resistance to fluid flow and allowing increased fluid flow through the fabric filter. Reverse pulse-jet cleaning has been used with fabric filters in arrangements and is described in U.S. Pat. Nos. 4,218,227; 4,331,459; 5,562,251 and 5,887,797 and U.S. Published Patent Application No. 2005/0120881. For example, U.S. Pat. No. 4,218,227 discloses cleaning pulse-jets provided by air flowing through an opening in a pipe. The air is directed into a fabric filter through a venturi attached to a tubesheet. U.S. Pat. No. 4,331,459 discloses cleaning pulse-jets provided by air flowing through a nozzle having a valve located in the nozzle. U.S. Pat. Nos. 5,562,251 and 5,887,797 disclose cleaning pulse jets provided by air flowing through a multi-piece nozzle. A restrictor is located in the nozzle. U.S. Published Patent Application No. 2005/0120881 discloses cleaning pulse-jets provided by air flowing through a multi-piece nozzle.

### BRIEF DESCRIPTION OF THE INVENTION

The invention provides advantages over the known fabric filter cleaning by permitting a more effective cleaning pulse delivered to fabric filters at a given delivery supply of fluid flowing through a simplified nozzle design. A filter cleaning system, according to one aspect of the invention, is for use with a fabric filter mounted in a housing and defining an upstream side at which particulates are separated from a fluid stream passing through the filter and collected. The fabric filter also has a downstream side that is substantially free of the particulates. The filter cleaning system includes a blowpipe for supplying a pressurized fluid. A one-piece nozzle is made from a tubular member having a substantially constant cross-section extending along the length of the member. The nozzle is attached to the blowpipe at a first end portion. The nozzle is in fluid communication with the blowpipe to direct a portion of the pressurized fluid from a second opposite end portion into the downstream side of the filter to dislodge particulates from the upstream side. An aspirator is located upstream and spaced from the second end portion of the nozzle. The aspirator enables extra fluid to be delivered from the second end portion of the nozzle than is delivered from the blowpipe to the first end portion of the nozzle.

The nozzle has a first area through which pressurized fluid may flow. The aspirator has a second area through which aspirator fluid may flow. The ratio of the first area to the second area is in the range of 0.5:1 to 5.0:1 and preferably is in the range of 1.0:1 to 2.0:1. The aspirator increases the cleaning jet effectiveness of the fluid from the nozzle in the range of 3% to 40% and preferably in the range of 10% to 30%.

The aspirator is formed in the first end portion of the nozzle. The nozzle is permanently attached to the blowpipe. The aspirator draws the extra air in by blowpipe delivery air flowing through the nozzle across the aspirator.

Another aspect of the invention is a method of cleaning a gas turbine inlet filter mounted in a housing and defining an upstream side at which particulates are separated from a fluid stream passing through the filter. The filter has a downstream side substantially free of the particulates. The method includes supplying pressurized fluid in a blowpipe. A portion of the pressurized fluid is directed from an outlet end portion of a nozzle into the downstream side of the filter to dislodge particles from the upstream side. The nozzle being one-piece and made from a tubular member having a substantially constant cross-section extending along the length of the member. The nozzle is permanently attached to the blowpipe at an opposite inlet end portion. The nozzle is in fluid communication with the blowpipe. An extra volume of fluid is delivered through an aspirator to the downstream side of the filter than is delivered to the nozzle from the blowpipe to dislodge particulates from the upstream side. The aspirator is formed in the nozzle in the inlet end portion of the nozzle.

The delivering step includes the aspirator drawing the extra air in by blowpipe delivery air flowing through the nozzle across the aspirator. The delivering step includes delivering pressurized fluid to the nozzle to flow through a first area and in which the aspirator has a second area through which the additional fluid may flow. The ratio of the first area to the second area is in the range of 0.5:1 to 5.0:1. The delivering step includes providing increased cleaning jet effectiveness of the fluid flowing through the nozzle in the range of 3% to 40%. The delivering step includes providing the aspirator in the first end portion of the nozzle.

### BRIEF DESCRIPTION OF THE DRAWINGS

Further features of the invention will become apparent to those skilled in the art to which the invention relates from reading the following description with reference to the accompanying drawings, in which:

FIG. 1 is a perspective view, taken from the outlet or downstream side of a portion of a gas turbine intake filter system having a filter cleaning system made according to one aspect of the invention;

FIG. 2 is a perspective view, taken from the inlet or upstream side of a portion of a gas turbine intake filter system;

FIG. 3 is a cross-sectional view of the portion of the gas turbine intake filter system taken approximately along the line 3-3 in FIG. 2;

FIG. 4 is an elevational view, partly in section, of the portion of the gas turbine intake filter system depicted in FIGS. 1-3, taken approximately along the line 4-4 in FIG. 3;

FIG. 5 is a top plan view, partly in section, of the portion of the gas turbine intake filter system depicted in FIGS. 1-4, taken approximately along the line 5-5 in FIG. 4;

FIG. 6 is an enlarged cross-sectional view of a nozzle of the filter cleaning system according to one aspect of the invention; and

FIG. 7 is an enlarged perspective view of the nozzle of the filter cleaning system illustrated in FIG. 6.

### DETAILED DESCRIPTION OF THE INVENTION

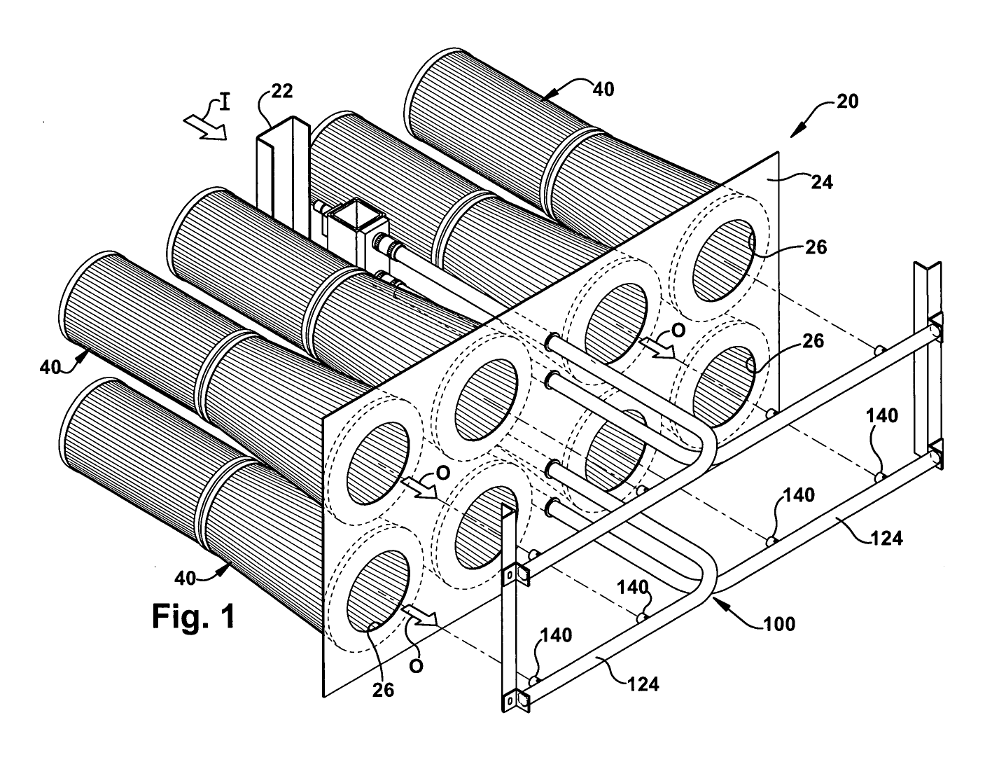

The system and method of cleaning a fabric filter are disclosed below by way of example and not limitation. The system and method are useable with a variety of fabric filter arrangements. FIGS. 1 through 5 depict an exemplary fabric filter arrangement. The exemplary fabric filter arrangement illustrated is particularly suitable as a gas turbine intake filter system 20.

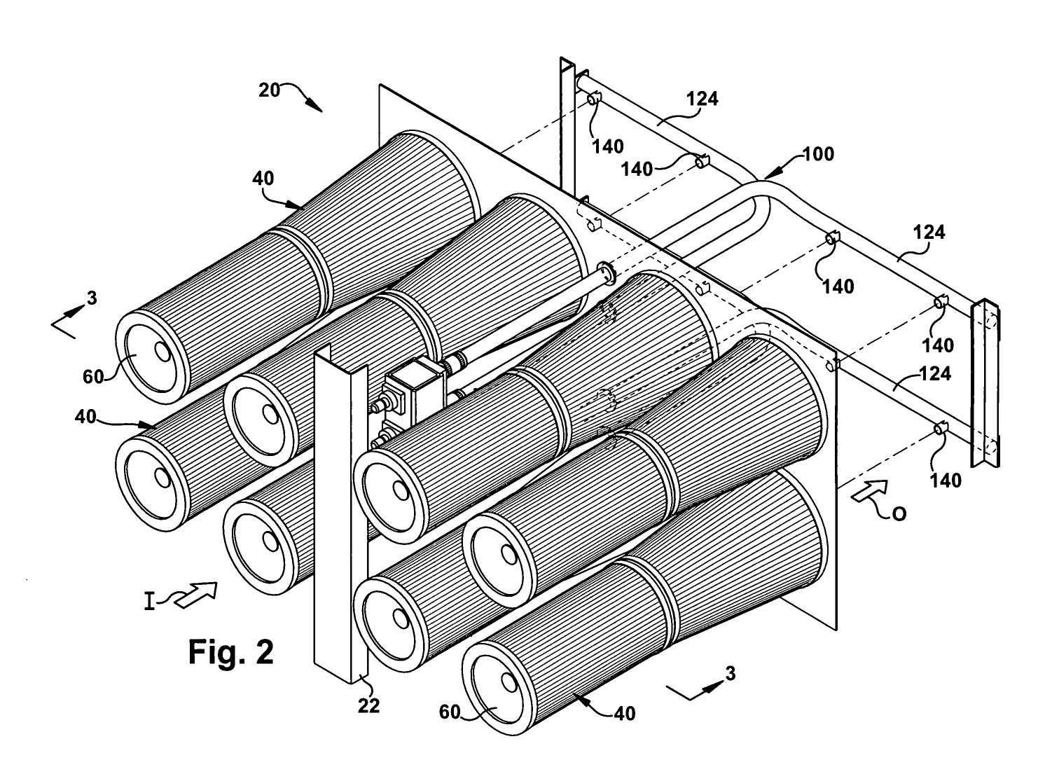

In FIGS. 1-2, particulate-laden fluid, such as air, is drawn into the gas turbine intake filter system 20 in the direction indicated by the arrow I. The gas turbine intake filter system 20 includes a housing (not shown) and a frame 22 that is used to support a tube sheet 24 and the housing. The tube sheet 24 includes a plurality of openings 26. The gas turbine intake filter system 20 includes a plurality of fabric filter assemblies 40 supported by the tube sheet 24. The fabric filter assemblies 40 are mounted adjacent to the openings 26 at an upstream side of the tube sheet 24, as is shown.

Air is cleaned in the fabric filter assemblies 40. The cleaned air flows downstream from the openings 26 in the tube sheet 24 as indicted by arrows O (FIG. 1) into a downstream use component, such as, a gas turbine for power generation. Each of the illustrated fabric filter assemblies 40 includes at least one filter element 42, 44 positioned to clean the air before it is used by components located downstream of the filter assemblies.

Air to be cleaned flows through the filter elements 42, 44. The filter elements 42, 44 are positioned in air flow communication with an opening 26 in the tube sheet 24. The cleaned air will flow through the opening 26 and then to downstream components.

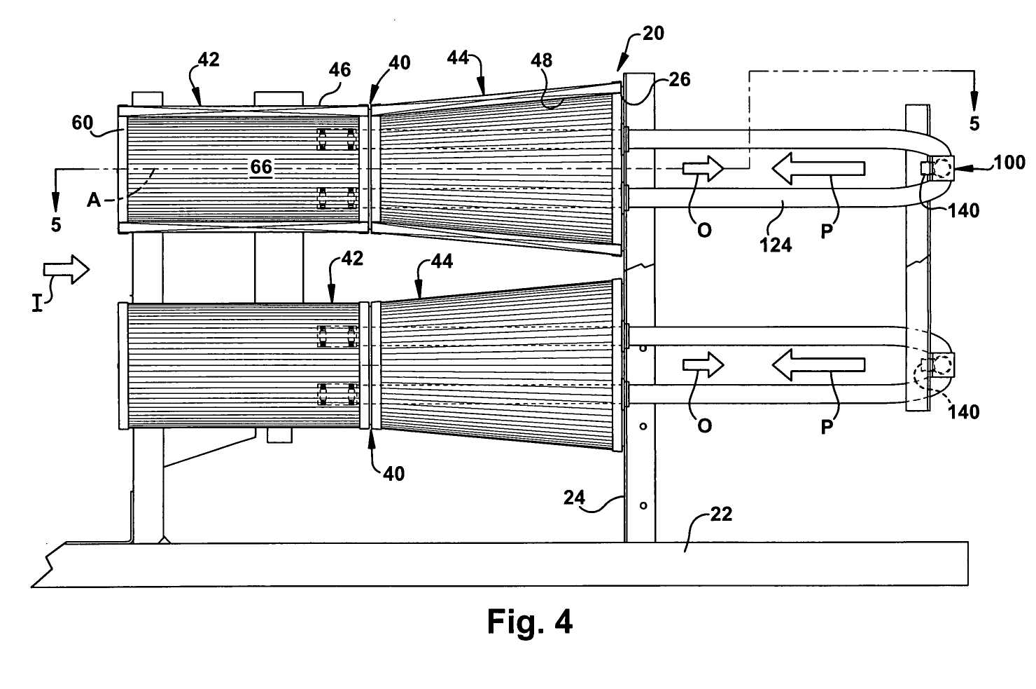

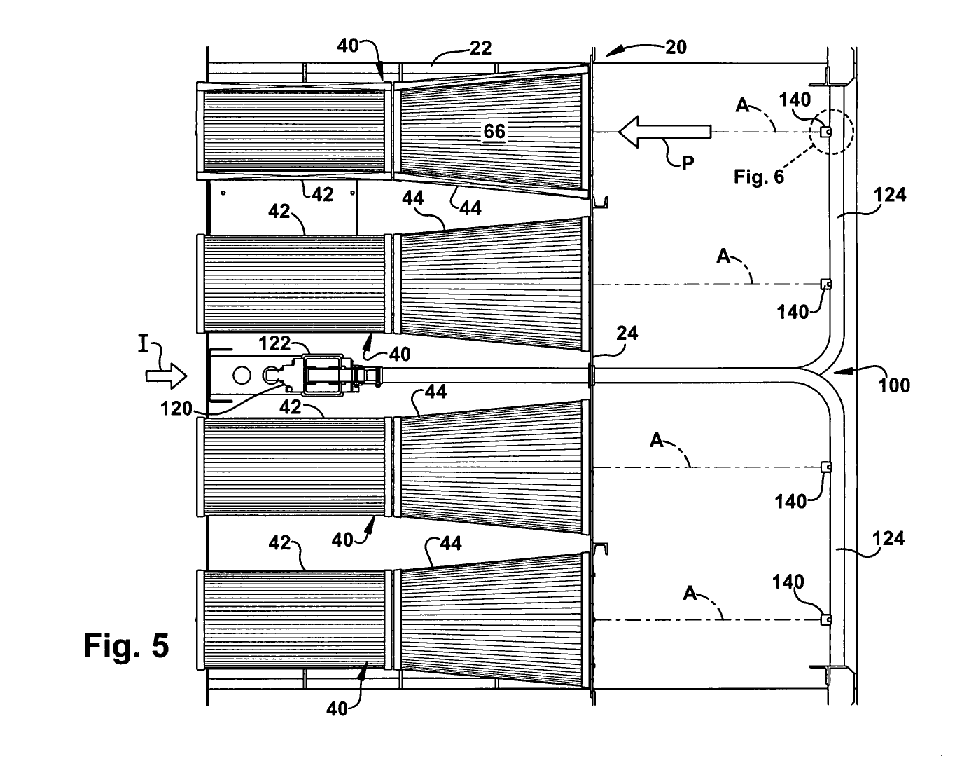

Referring to FIGS. 4 and 5, the filter assembly 40 includes at least a first filter element 42 and a second element 44 made from flexible, permeable fabric filter media material. Each of the first and second filter elements 42, 44 has an outer or upstream surface 46 (FIG. 4) and an inner or downstream surface 48. The first filter element 42 is tubular and has a cylindrical shape. The second filter element 44 is tubular and has a frusto-conical shape. The pair of filter elements 42, 44 are arranged in axial engagement. One end of the first filter element 42 is closed by a removable end cap 60. The filter elements 42, 44 are held in place by mounting structure (not shown) attached to the tube sheet 24 and end cap 60. Each of the filter assemblies 40 defines a clean air plenum 66 by its downstream surface 48.

After a period of use, a pressure drop across each of the filter assemblies 40 will increase due to the accumulation of particulates separated from the air stream and accumulated on the filter assemblies. These particulates can be harmful to downstream components, such as a gas turbine, if not removed from the air stream. The filter assemblies 40 are periodically cleaned by directing a flow of relatively higher pressure fluid (such as a pulse P of compressed gas illustrated in FIGS. 4-5). The reverse pulse P is directed into the clean air plenum 66 of each filter assembly 40, essentially in a diverging direction along a longitudinal central axis A of the filter assembly. The reverse cleaning pulse P flows from the downstream side 48 of the filter assembly 40 to the upstream side 46 of the filter assembly 40. This will remove at least some, and preferably a significant amount, of the particulates from the filter assembly 40 and reduce the restriction across the filter assembly 40 caused by particulates separated from the air stream accumulating on or in the fabric filter media.

Referring to FIGS. 4-5, the reverse pulse-jet cleaning system 100 according to one aspect of the invention is illustrated. The reverse cleaning pulse P is provided by the cleaning system 100. Directing a pulse P of compressed gas is done periodically into each filter assembly 40 through the downstream surface 48. By “periodic”, it is meant that the reverse pulse-jet system 100 can be programmed or can be manually operated such that in desired periods, after a certain length of time or after a certain amount of restriction is detected in a known manner, there will be a pulse P of compressed gas directed through the downstream surface 48 of the filter assembly 40.

In general, the reverse pulse-jet cleaning system 100 uses a flow of higher pressure fluid, such as pulses P of compressed gas, such as air, to clean the filter assemblies 40. By “pulse”, it is meant a flow of fluid at a pressure at least 25%, and preferably at least 50%, higher than the pressure of the outlet flow O through filter assembly 40 for a limited time duration. The time duration is generally under 0.5 second, preferably under 0.3 second, and in some cases less than 0.05 second. It has been found that for certain applications, it is beneficial to direct the pulse P of compressed gas at a force of between 5-55 inches of water and flow at a rate in the range of 200 to 3000 CFM net flow, with developed “reverse”, or net reverse flushing flow of 25% to 100% of outlet flow O from the filter assembly 40. Preferably, the “net” reverse-air is at least 25 to 50% more than the normal outlet flow O of the filter assemblies 40 being cleaned.

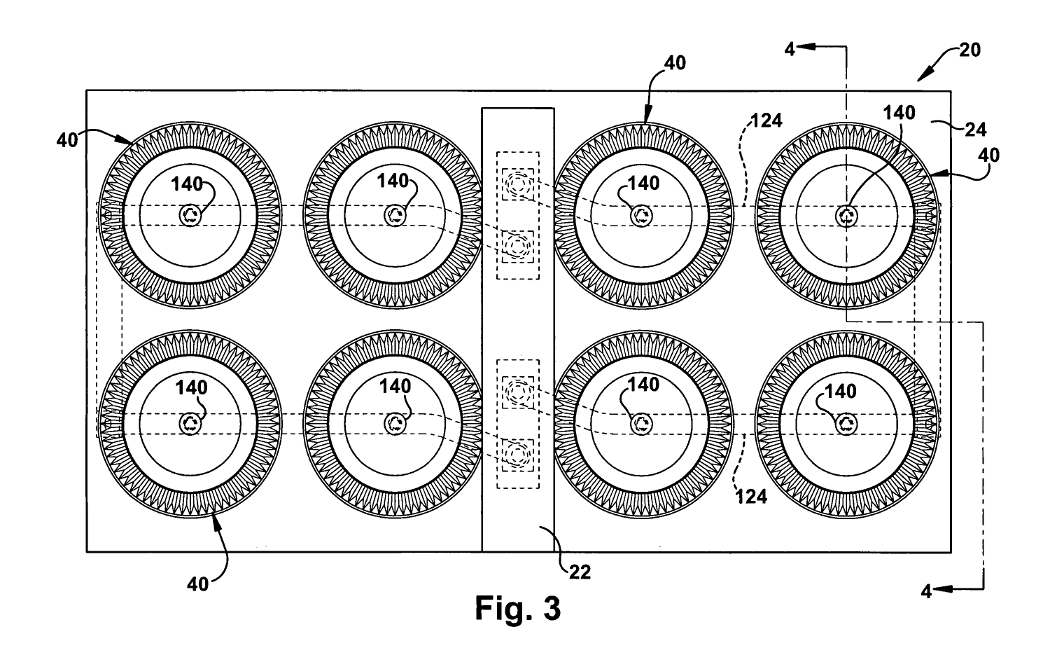

As best seen in FIG. 5, the reverse pulse-jet cleaning system 10 includes a plurality of pulse valves 120. Each valve 120 is operably connected to a compressed air manifold 122 that supplies compressed fluid, such as air. Each of the valves 120 is arranged to direct the compressed fluid through a respective blowpipe 124 and to a pair of nozzles 140. Periodically, the valves 120 are operated to allow a pulse P of compressed air to pass through the nozzles 140, through the openings 26 in the tube sheet 24, and into the clean air plenum 66 of the filter assemblies 40. The nozzles 140 are positioned a predetermined distance from the tube sheet 24 and located along the axis A of a respective filter assembly 40, or centrally as illustrated in FIG. 3. The predetermined distance is the range of 8 inches to 36 inches, and preferably 20-31 inches when the diameter of the opening 26 in the tube sheet 24 is approximately 15 inches.

The blowpipe 124 is permanently secured to the tube sheet 24 or frame 22 by a clamp or bracket. The nozzle 140 of the reverse pulse-jet cleaning system 100 is permanently attached to the blowpipe 124, such as by welding. In the illustrated embodiment, the nozzle 140 is a fabricated from a metal tubular member and has a substantially constant circular cross-section extending along its length in a direction parallel to the longitudinal central axis A.

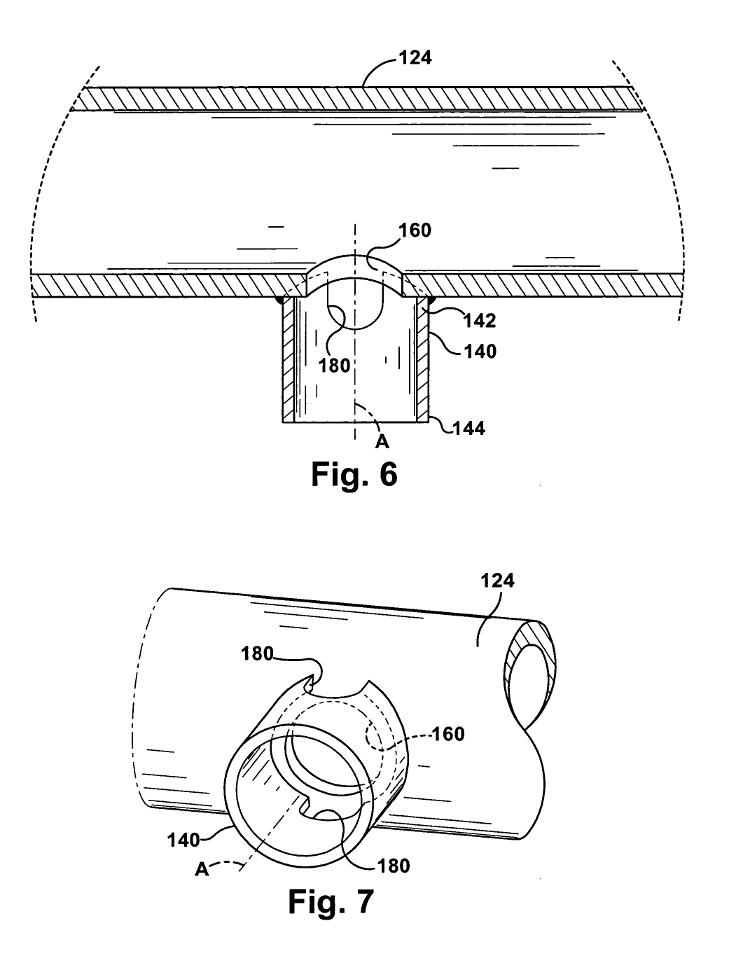

The nozzle 140 (FIG. 6) has a first end portion 142 and a second end portion 144. The nozzle 140 is welded to the blowpipe 124 at the first end portion 142 around an opening 160 in the blowpipe. The nozzle 140 defines a passage for the primary fluid delivered from the blowpipe 124. The nozzle 140 includes an aspirator 180 defined by a pair of equal size ports formed in the first end portion 142.

The nozzle 140 has a first area defined by an opening 160 in the blowpipe 124 through which pressurized fluid may flow. The inner diameter of the nozzle 140 is substantially equal to or just slightly greater than the diameter of the opening 160. The ports of the aspirator 180 define a second area through which extra or secondary aspirator fluid may flow. The ratio of the first area to the second area is in the range of 0.5:1 to 5.0:1 and preferably is in the range of 1.0:1 to 2.0:1.

The aspirator 180 draws extra air in by flowing through the nozzle 140 across the ports defining the aspirator. The air passes through the opening 160 in the blow pipe 124 across the aspirator 180 location. This extra or secondary air is drawn in by lower pressure existing near the ports of the aspirator 180. An area of low pressure is created by the fast flow of the air discharging from the opening 160 in the blow pipe 124 across the aspirator 180 (primary air) that pulls the extra or additional (secondary) air through the ports defining the aspirator.

These two airstreams combine to increase total flow and create the “enhanced” reverse cleaning pulse P. The large separation distance between the discharge of the nozzle 140 encourages additional entrainment of air, increasing the total reverse flow cleaning pulse P volume to two to five times that of the air volume issuing from the opening 160 in the blow pipe 124. Thus, the aspirator 180 increases the cleaning jet effectiveness of the fluid from the nozzle in the range of 3% to 40% and preferably in the range of 10% to 30% to that of what would be delivered by air delivered only through the opening 160 in the blow pipe 124.

In particular, an actuator of the reverse pulse-jet system 100 will provide a signal to open the pulse valve 120. When the valve 120 opens, a jet of compressed fluid flows from the manifold 122 through the valve and to the blowpipe 124. The jet enters the nozzle 140 as a primary fluid jet. The primary fluid jet is then supplemented by secondary air flow from the aspirator 180. The enhanced cleaning pulse P is directed into the clean air plenum 66 such that the pulse fills the aperture 26 adjacent the clean air plenum 66 of the filter assembly 40. This pulse P allows maximum cleaning air to be directed into the full axial extent of the filter assemblies 40 economically.

Another aspect of the invention is a method of cleaning a filter assembly 40 mounted in a housing (not shown) and defining the upstream side 46 at which particulates are separated from a fluid stream passing through the filter. The downstream side 48 of the filter assembly 40 is substantially free of the particulates. The method includes supplying pressurized fluid in a blowpipe 124. A portion of the pressurized fluid is directed from an outlet end portion 144 of the nozzle 140 into the plenum 66 defined by the downstream side 48 of the filter assembly 40 to dislodge particulates from the upstream side 46. An aspirator 180 delivers an additional volume of fluid than is delivered to the nozzle 140 from opening 160 in the blowpipe 124. The aspirator 180 has a portion formed in the nozzle 140 in the inlet end portion 142 of the nozzle.

From the above description of at least one aspect of the invention, those skilled in the art will perceive improvements, changes and modifications. Such improvements, changes and modifications within the skill of the art are intended to be covered by the appended claims.

Having described at least one aspect of the invention, what is claimed is:

1. A filter cleaning system for use with a fabric filter mounted in a housing and defining an upstream side at which particulates are separated from a fluid stream passing through the filter and collected and a downstream side that is substantially free of the particulates, the filter cleaning system comprising:
a blowpipe for supplying a pressurized fluid;
a one-piece nozzle made from a tubular member having a substantially constant cross- section extending along the length of the member, the nozzle being attached to the blowpipe at a first end portion, the nozzle in fluid communication with the blowpipe to direct a portion of the pressurized fluid from a second opposite end portion into the downstream side of the filter to dislodge particulates from the upstream side; and
an aspirator at an upstream location spaced from the second end portion of the nozzle, the aspirator enabling an additional volume of fluid to be delivered from the second end portion of the nozzle than is delivered from the blowpipe to the first end portion of the nozzle.

2. The filter cleaning system of claim 1 wherein the nozzle has a first area through which pressurized fluid may flow and the aspirator has a second area through which aspirator fluid may flow, the ratio of the first area to the second area is in the range of 0.5:1 to 5.0:1.

3. The filter cleaning system of claim 1 wherein the nozzle has a first area through which pressurized fluid may flow and the aspirator has a second area through which aspirator fluid may flow, the ratio of the first area to the second area is in the range of 1.0:1 to 2.0:1.

4. The filter cleaning system of claim 1 wherein the aspirator increases the cleaning jet effectiveness of the fluid from the nozzle in the range of 3% to 40%.

5. The filter cleaning system of claim 1 wherein the aspirator increases the cleaning jet effectiveness of the fluid from the nozzle in the range of 10% to 30%.

6. The filter cleaning system of claim 1 wherein the aspirator is formed in the first end portion of the nozzle.

7. The filter cleaning system of claim 1 wherein the nozzle is permanently attached to the blowpipe.

8. The filter cleaning system of claim 1 wherein the aspirator draws secondary air into the nozzle by blowpipe delivery air flowing through the nozzle across the aspirator.

9. A filter cleaning system for a gas turbine inlet filter mounted in a housing and defining an upstream side at which particulates are separated from a fluid stream passing through the filter and a downstream side substantially free of the particulates, the filter cleaning system comprising:
a blowpipe for supplying a pressurized fluid;
a one-piece nozzle made from a tubular member having a substantially constant cross-section extending along the length of the member, the nozzle being permanently attached to the blowpipe at a first end portion, the nozzle in fluid communication with the blowpipe to direct a portion of the pressurized fluid from a second opposite end portion into the downstream side of the filter to dislodge particulates into the upstream side; and
an aspirator portion formed in the nozzle at an upstream location spaced from the second end portion of the nozzle, the aspirator portion enabling an additional volume of fluid to be delivered from the second end portion of the nozzle than is delivered from the blowpipe to the first end portion of the nozzle.

10. The filter cleaning system of claim 9 wherein the nozzle has a first area through which pressurized fluid may flow and the aspirator has a second are A through which aspirator fluid may flow, the ratio of the first area to the second area is in the range of 0.5 to 5.0.

11. The filter cleaning system of claim 9 wherein the nozzle has a first area through which pressurized fluid may flow and the aspirator has a second area through which aspirator fluid may flow, the ratio of the first area to the second area is in the range of 1.0 to 2.0.

12. The filter cleaning system of claim 9 wherein the aspirator increases the cleaning jet effectiveness of the fluid from the nozzle in the range of 3% to 40%.

13. The filter cleaning system of claim 9 wherein the aspirator increases the cleaning jet effectiveness of the fluid from the nozzle in the range of 10% to 30%.

14. The filter cleaning system of claim 9 wherein the aspirator draws secondary air into the nozzle by blowpipe delivery air flowing through the nozzle across the aspirator.

15. A method of cleaning a gas turbine inlet filter mounted in a housing and defining an upstream side at which particulates are separated from a fluid stream passing through the filter and a downstream side substantially free of the particulates, the method comprising the steps of:
supplying pressurized fluid in a blowpipe;
directing a portion of the pressurized fluid from an outlet end portion of a nozzle into the downstream side of the filter to dislodge particles from the upstream side, the nozzle being one-piece and made from a tubular member having a substantially constant cross-section extending along the length of the member, the nozzle being permanently attached to the blowpipe at an opposite inlet end portion, the nozzle in fluid communication with the blowpipe; and
delivering through an aspirator additional volume of fluid to the downstream side of the filter that is directed to the nozzle from the blowpipe to dislodge particulates from the upstream side, the aspirator portion formed in the nozzle in the inlet end portion of the nozzle.

16. The method of claim 15 wherein the delivering step includes the aspirator drawing secondary air into the nozzle by blowpipe delivery air flowing through the nozzle across the aspirator.

17. The method of claim 15 wherein the delivering step includes delivering pressurized fluid to the nozzle to flow through a first area through and in which the aspirator has a second area through which the additional fluid may flow, the ratio of the first area to the second area is in the range of 0.5:1 to 5.0:1.

18. The method of claim 15 wherein the delivering step includes providing increased cleaning jet effectiveness of the fluid flowing through the nozzle in the range of 3% to 40%.

19. The method of claim 15 wherein the delivering step includes providing the aspirator in the first end portion of the nozzle.
